(19) United States
(12) Patent Application Publication
(10) Pub. No.: US 2019/0026961 A1
(43) Pub. Date: Jan. 24, 2019

(54) DRONE-BASED DIAGNOSTIC SYSTEM FOR ACTIVE GRILLE SHUTTERS OF A VEHICLE

(71) Applicant: Ford Global Technologies, LLC, Dearborn, MI (US)

(72) Inventor: Aed M. Dudar, Canton, MI (US)

(21) Appl. No.: 15/653,105

(22) Filed: Jul. 18, 2017

(51) Int. Cl. G07C 5/00; G05D 1/00; B60K 11/08; B64C 39/02; B64D 47/08; G06T 7/00

(52) U.S. Cl. CPC G07C 5/008; G05D 1/0022; B60K 11/085; B64C 39/024; B64D 47/08; G06T 2207/20224; B64C 2201/127; G05D 2201/0207; G06T 2207/30252; G06T 2207/10048; G06T 7/001

(57) ABSTRACT

Method and apparatus are disclosed for a drone-based diagnostic system for active grille shutters of a vehicle. An example vehicle diagnostic system includes a drone and a diagnostic server. The drone sends a first command to open a vehicle's active grille shutters, captures a first image of a front of the vehicle, sends a second command to close the vehicle's the active grille shutters, and capture sa second image of the front of the vehicle. The diagnostic server determines whether the active grille shutters are malfunctioning based on the first and second images received from the drone.

### TECHNICAL FIELD

The present disclosure generally relates to detecting failures in systems of a vehicle and, more specifically, a drone-based diagnostic system for active grille shutters of a vehicle.

### BACKGROUND

To meet fuel economy standards, vehicles are being equipped with active grille shutters. Active grille shutters automatically close to block airflow through a vehicle cooling system when the cooling is not needed. For example, air flowing around the hood of the vehicle may be enough to prevent the engine compartment from overheating when the vehicle is traveling at high speed. Closing the active grille shutters improves aerodynamics by reducing drag on the vehicle. The active grille shutters are open to reduce the underhood temperature when needed. Active grille shutters typically have position feedback sensors, such as hall effect sensors. However, the existing diagnostic sensors may failure to identify a failure of the active grille shutters. For example, the sensors themselves may be malfunctioning and the mechanical linkage between the shutters and the motors may be broke while the motor still functions without the load.

### SUMMARY

The appended claims define this application. The present disclosure summarizes aspects of the embodiments and should not be used to limit the claims. Other implementations are contemplated in accordance with the techniques described herein, as will be apparent to one having ordinary skill in the art upon examination of the following drawings and detailed description, and these implementations are intended to be within the scope of this application.

Example embodiments are disclosed for a drone-based diagnostic system for active grille shutters of a vehicle. An example vehicle diagnostic system includes a drone and a diagnostic server. The drone sends a first command to open a vehicle's active grille shutters, captures a first image of a front of the vehicle, sends a second command to close the vehicle's the active grille shutters, and capture sa second image of the front of the vehicle. The diagnostic server determines whether the active grille shutters are malfunctioning based on the first and second images received from the drone.

An example method includes sending, by a wireless transceiver of a drone, a first command to open a vehicle's active grille shutters and capturing, by a camera of the drone, a first image of a front of the vehicle. The method also includes sending, by the wireless transceiver of a drone, a second command to close the vehicle's the active grille shutters, and capturing, by the camera of the drone, a second image of the front of the vehicle. Additionally, the method includes determining, by a diagnostic server, whether the active grille shutters are malfunctioning based on the first and second images received from the drone.

### BRIEF DESCRIPTION OF THE DRAWINGS

For a better understanding of the invention, reference may be made to embodiments shown in the following drawings. The components in the drawings are not necessarily to scale and related elements may be omitted, or in some instances proportions may have been exaggerated, so as to emphasize and clearly illustrate the novel features described herein. In addition, system components can be variously arranged, as known in the art. Further, in the drawings, like reference numerals designate corresponding parts throughout the several views.

FIGS. 1A and 1B illustrate a drone inspecting the active grille shutters of a vehicle in accordance with the teachings of the invention.

FIG. 2 is a block diagram of the electronic components of the drone of FIG. 1.

FIG. 3 is a block diagram of the electronic components of the vehicle of FIG. 1.

FIG. 4 is a flowchart of a method to diagnose the active grille shutters, which may be implemented by the diagnostic server, the drone, and/or the vehicle of FIG. 1.

### DETAILED DESCRIPTION OF EXAMPLE EMBODIMENTS

While the invention may be embodied in various forms, there are shown in the drawings, and will hereinafter be described, some exemplary and non-limiting embodiments, with the understanding that the present disclosure is to be considered an exemplification of the invention and is not intended to limit the invention to the specific embodiments illustrated.

As disclosed below, a drone-based diagnostic system uses drones to capture images of the front of a vehicle to determine whether the active grille shutters of the vehicle are functioning properly. The drones are autonomous vehicles (e.g., small unmanned aerial vehicles (sUAVs), unmanned ground vehicles (UGVs), etc.) with a camera and a communications module to communicate with the vehicle. When a diagnostic server detects a vehicle park in a designated location, the diagnostic server dispatches a drone to inspect the active grille shutters of the vehicle. The drone maneuvers to the vehicle. Via the communications module, the drone commands the vehicle to open its active grille shutters. The drone captures an image of the front of the vehicle. In some examples, at night, the drone captures the image with an infrared camera. The drone then, via the communications module, commands the vehicle to close its active grille shutters. The drone captures another image of the front of the vehicle.

The diagnostic server compares the images to determine whether the active grille shutters changed positions in response to the commands. For example, when the active grille shutters are stuck closed, the image analysis would determine that the position of the active grille shutters did not change. In some examples, when the images are captured during the day, the diagnostic server using image subtraction and/or comparing the captured images with stored baseline images of the active grille shutters opened and closed. In some examples, when the images are captured during the night, the infrared images are compared to determine whether the ratio of light to dark pixels changed and/or whether the average pixel brightness has changed. When the diagnostic server determines that the active grille shutters of the vehicle are malfunctioning, the diagnostic server schedules the vehicle for maintenance.

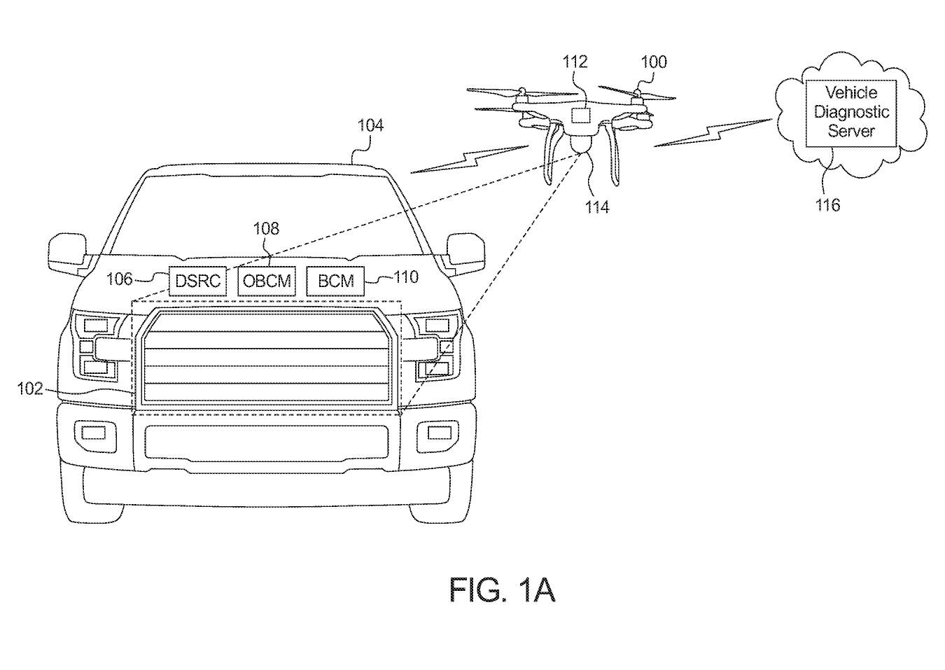

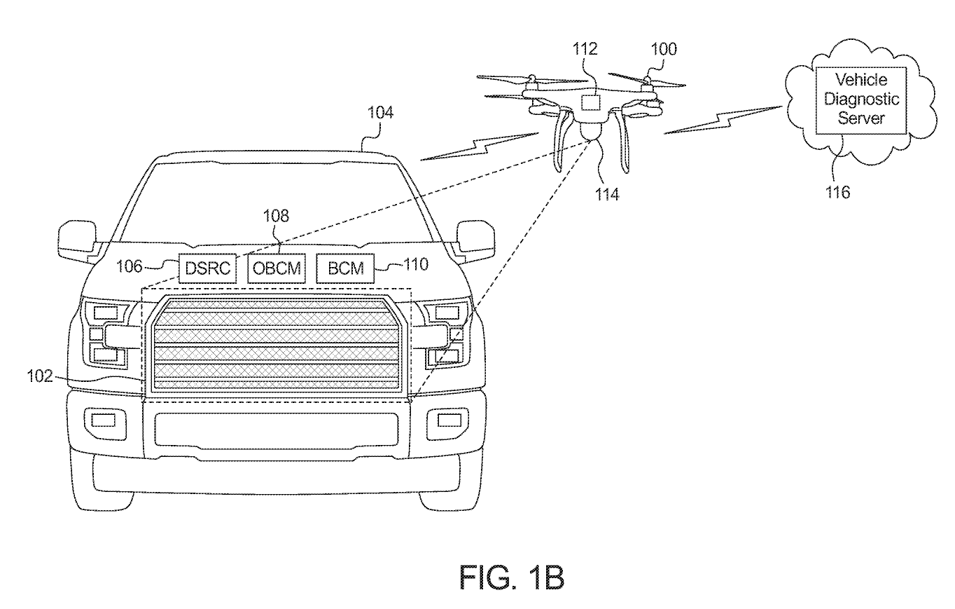

FIGS. 1A and 1B illustrate a drone 100 inspecting the active grille shutters 102 of a vehicle 104 in accordance with the teachings of the invention. In the illustrated example of FIG. 1A, the active grille shutters 102 are closed. In the illustrated example of FIG. 1B, the active grille shutters 102 are opened.

The vehicle 104 may be a standard gasoline powered vehicle, a hybrid vehicle, an electric vehicle, a fuel cell vehicle, and/or any other mobility implement type of vehicle. The vehicle 104 includes parts related to mobility, such as a powertrain with an engine, a transmission, a suspension, a driveshaft, and/or wheels, etc. The vehicle 104 may be non-autonomous, semi-autonomous (e.g., some routine motive functions controlled by the vehicle 104), or autonomous (e.g., motive functions are controlled by the vehicle 104 without direct driver input). In some examples, the vehicle 104 is part of a fleet of autonomous vehicles. In the illustrated example the vehicle 104 includes the active grille shutters 102, a dedicated short range communication (DSRC) module 106, a on-board communications module (OBCM) 108, and a body control module (BCM) 110.

The active grille shutters 102 are mounted in front of a radiator of the vehicle 104. The active grille shutters 102 automatically open and close to affect the cooling of the engine compartment of the vehicle 104 and the aerodynamic drag on the vehicle 104. When the active grille shutters 102 are open, airflow through the active grille shutters 102 cools the engine compartment. When the active grille shutters 102 are closed, the aerodynamic drag of the vehicle 104 is reduced. For example, when the vehicle 104 is driving on a highway at relatively high speeds, the airflow over the vehicle 104 may be sufficient to cool the engine compartment and decreasing the aerodynamic drag that highway speeds may improve fuel economy. The active grille shutters 102 include linkage connected to driving motor(s) to control the position of the active grille shutters 102.

The DSRC module 106 includes hardware, antenna(s), radio(s) and software to broadcast messages and to establish connections between the vehicles, infrastructure-based modules, and mobile device-based modules. In the illustrated example, the DSRC module 106 communicatively couples to a corresponding DSRC module 112 of the drone 100. More information on the DSRC network and how the network may communicate with vehicle hardware and software is available in the U.S. Department of Transportation's Core June 2011 System Requirements Specification (SyRS) report (available at http://www.its.dot.gov/meetings/pdf/CoreSystem_SE_SyRS_RevA%20(2011-06-13).pdf), which is hereby incorporated by reference in its entirety along with all of the documents referenced on pages 11 to 14 of the SyRS report. DSRC systems may be installed on vehicles and along roadsides on infrastructure. DSRC systems incorporating infrastructure information is known as a “roadside” system. DSRC may be combined with other technologies, such as Global Position System (GPS), Visual Light Communications (VLC), Cellular Communications, and short range radar, facilitating the vehicles communicating their position, speed, heading, relative position to other objects and to exchange information with other vehicles or external computer systems. DSRC systems can be integrated with other systems such as mobile phones. In some examples, the DSRC module 106 includes an integrated global positioning system (GPS) receiver.

The example DSRC module 106 implements the DSRC protocol. However, the DSRC module 106 may implement communication protocols used to communicatively couple vehicles, roadside nodes, and/or mobile devices. Most of these systems are either pure DSRC or a variation of the IEEE 802.11 wireless standard. However, besides the pure DSRC system it is also meant to cover dedicated wireless communication systems between cars and roadside infrastructure system, which are integrated with GPS and are based on an IEEE 802.11 protocol for wireless local area networks (such as, 802.11p, etc.).

Alternatively or additionally, the vehicle 104 includes an on-board communications module 108. The on-board communications module 108 communicatively couples with the drone 100 via a personal area network and/or a wireless local area network. The on-board communications module 108 includes wireless network interfaces to enable communication the drone 100. The on-board communications module 108 also includes hardware (e.g., processors, memory, storage, antenna, etc.) and software to control the wireless network interfaces. In the illustrated example, the on-board communications module 108 includes one or more communication controllers for standards-based networks (e.g., local area wireless network (including IEEE 802.11 a/b/g/n/ac or others), Bluetooth®, Bluetooth® Low Energy, Zigbee®, Z-wave®, etc.).

The body control module 110 controls various subsystems of the vehicle 104. For example, the body control module 110 may control power windows, power locks, an immobilizer system, and/or power mirrors, etc. The body control module 110 includes circuits to, for example, drive relays (e.g., to control wiper fluid, etc.), drive brushed direct current (DC) motors (e.g., to control power seats, power locks, power windows, wipers, etc.), drive stepper motors, and/or drive LEDs, etc. In the illustrated example, the body control module 110 is electrically coupled to the active grille shutters 102 to control the position (e.g., opened or closed) of the active grille shutters 102. The body control module 110 controls the active grille shutters 102 in response to commands received from the drone 100 via the DSRC module 106 or the on-board communications module 108.

The drone 100 is an autonomous vehicle, such as a small unmanned aerial vehicle (sUAV) or an unmanned ground vehicle (UGV). In the illustrated example, the drone is a sUAV. The drone includes one or more cameras 114. In some examples, the cameras 114 include a standard camera (e.g., a camera that captures images in the visible spectrum) and an infrared camera. In some examples, the drone 100 includes a single camera with a visable spectrum mode and a infrared spectrum mode. In some examples, the camera(s) 112 capture still images and/or videos. Additionally, the drone includes the DSRC module 112 to communicatively couple with the vehicle 104. The DSRC module 112 includes hardware, antenna(s), radio(s) and software to broadcast messages and to establish connections between the vehicle 104 and the drone 100 and/or the diagnostic server 116 and the drone 100.

The drone 100 determines the location and orientation of the vehicle 104 when dispatched by the diagnostic server 116. In some examples, the drone 100 receives location data from the diagnostic server 116. Alternatively or additionally, the drone 100 receives location information from the vehicle 104. The location information may include GPS coordinates, local grid coordinates, and/or a parking space identifier, etc. The drone 100 travels to the location of the vehicle 104 and determines the orientation of the vehicle 104 to locate the active grille shutters 102. In some examples, the drone 100 confirms the identity of the vehicle 104 via license plate recognition and/or communication with the vehicle 104.

When in position to capture images of the active grille shutters 102, the drone 100, via the DSRC module 112, sends a command for the vehicle 104 to open the active grille shutters 102. The drone 100 captures an image of the active grille shutters 102. The drone 100 then sends a command to the vehicle 104 for the vehicle 104 to close the active grille shutters 102. The drone 100 captures an image of the active grille shutters 102. In some examples, during the day, the drone 100 uses the standard camera 114. In some examples, during the night, the drone uses the infrared camera 114. In some examples, the drone 100 repeats the cycle of commanding the vehicle 104 to open and shut the active grille shutters 102 and capturing images in each state of the active grille shutters 102. The drone 100 uploads the images to the diagnostic server 116.

In some examples, the drone 100 requests, via the DSRC module 112, the coolant temperature (e.g., as measured by a coolant temperature sensor of the vehicle 104) from the vehicle 104. In some such examples, when the engine coolant temperature of the vehicle 104 does not satisfy (e.g., is less than) a coolant threshold, the drone 100 sends a message to the diagnostic server 116 that the vehicle 104 cannot be reliably diagnosed. For example, the coolant threshold may be 200 degrees Fahrenheit. In some examples, when the vehicle 104 is parked for a threshold period of time (e.g., two minutes, etc.) the drone sends a message to the vehicle 104 to cause the vehicle 104 to activate its electric coolant pump to circulate the latent engine heat (e.g., via the coolant) into the radiator before capturing images of the front of the vehicle 104.

The diagnostic server 116 includes processor(s) and memory and a communications interface to communicatively couple to the drone 100 and the vehicle 104 (e.g., via the DSRC protocol, etc.). The diagnostic server 116 dispatches the drone 100 when a vehicle 104 parks. In some examples, the diagnostic server dispatches the drone 100 when multiple vehicles 104 are parked so that the drone can capture images of multiple vehicles 104 in one trip. When the diagnostic server 116 receives images from the drone associated with a vehicle 104, the diagnostic server 116 analyzes the images to determine whether the state of the active grille shutters 102 changes between the drone 100 issuing the command to the vehicle to open the active grille shutters 102 and to shut the active grille shutters 102. In some examples, when the images were captured during the day, the diagnostic server 116 uses image analysis techniques such as image subtraction. In some examples, when the images were captured during the night, the diagnostic server 116 uses image analysis techniques such as comparing the ratio of light pixels to dark pixels whether the average pixel brightness has changed. For example, then when the active grille shutters 102 are open (e.g., the active grille shutters 102 are not blocking the heat of the engine compartment), the ratio of light pixels to dark pixels is relatively high compared to then the active grille shutters 102 are closed (e.g., the active grille shutters 102 are blocking heat from the engine compartment). When the image analysis determines that the active grille shutters 102 are malfunctioning on the vehicle 104, the diagnostic server 116 designates the vehicle 104 for maintenance. Additionally, the diagnostic server 116 records the diagnostic results in a profile associated with the vehicle 104.

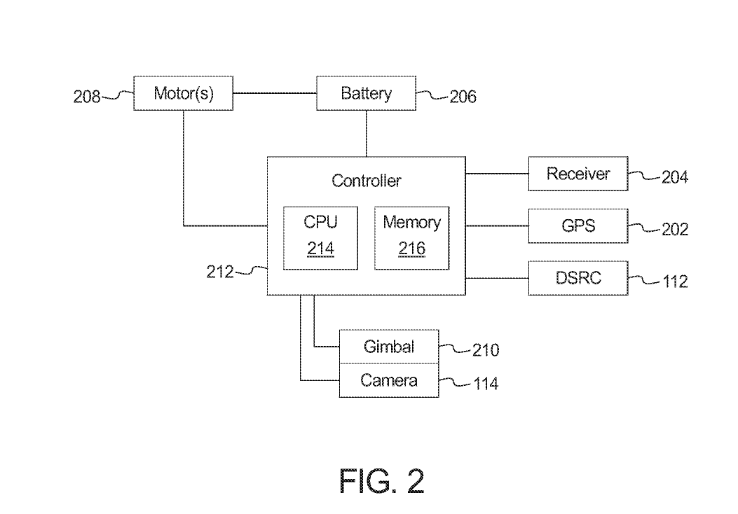

FIG. 2 is a block diagram of the electronic components 200 of the drone 100 of FIG. 1. In the illustrated example, the electronic components 200 include the DSRC module 112, the camera(s) 114, a GPS receiver 202, a communications module 204, a battery 206, motor(s) 208, a gimbal 210, and a controller 212. The GPS receiver 202 receives signals from the GSP system and provides the current position of the drone 100. The communications module 204 includes hardware (e.g., processors, memory, storage, antenna, etc.) and software to control wireless network interfaces. The communications module 204 includes one or more communication controllers for standards-based networks (e.g., local area wireless network (including IEEE 802.11 a/b/g/n/ac or others), Bluetooth®, Bluetooth® Low Energy, Zigbee®, Z-wave®, etc.). The battery 206 provides power to the drone 100. In some examples, the batteries are rechargeable. The motor(s) 208 provide(s) the motive power for the drone 100. The motor(s) 208 may be coupled to blades (e.g., when the drone 100 is a sUAV) or wheels/tracks (e.g., when the drone is a UGV). The gimbal 210 is a pivoting support for the camera(a) 114 that facilitates the camera(s) 114 bing aimed at a location (e.g., the front of the vehicle 104) independent of the rotation of the body of the drone 100.

The controller 212 includes a processor or controller 214 and memory 216. The processor or controller 214 may be any suitable processing device or set of processing devices such as, but not limited to: a microprocessor, a microcontroller-based platform, a suitable integrated circuit, one or more field programmable gate arrays (FPGAs), and/or one or more application-specific integrated circuits (ASICs). The memory 216 may be volatile memory (e.g., RAM, which can include non-volatile RAM, magnetic RAM, ferroelectric RAM, and any other suitable forms); non-volatile memory (e.g., disk memory, FLASH memory, EPROMs, EEPROMs, non-volatile solid-state memory, etc.), unalterable memory (e.g., EPROMs), and/or read-only memory, etc. In some examples, the memory 216 includes multiple kinds of memory, particularly volatile memory and non-volatile memory.

The memory 216 is computer readable media on which one or more sets of instructions, such as the software for operating the methods of the present disclosure can be embedded. The instructions may embody one or more of the methods or logic as described herein. In a particular embodiment, the instructions may reside completely, or at least partially, within any one or more of the memory 216, the computer readable medium, and/or within the processor 214 during execution of the instructions.

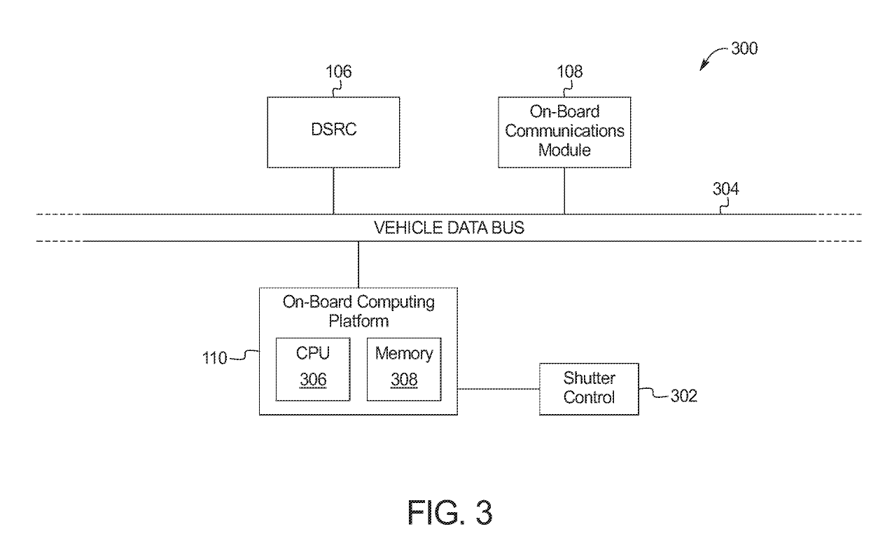

FIG. 3 is a block diagram of the electronic components 300 of the vehicle 104 of FIG. 1. In the illustrated example, the electronic components 300 include the DSRC module 106, the on-board communications module 108, the body control module 110, a shutter control 302, and a vehicle data bus 304. The shutter control 302 includes motors and/or circuitry to control the active grille shutters 102. The body control module 110 opens and shuts the active grille shutters 102 via the shutter control 302.

In the illustrated example, the body control module includes a processor or controller 306 and memory 308. The processor or controller 306 may be any suitable processing device or set of processing devices such as, but not limited to: a microprocessor, a microcontroller-based platform, a suitable integrated circuit, one or more field programmable gate arrays (FPGAs), and/or one or more application-specific integrated circuits (ASICs). The memory YYY may be volatile memory (e.g., RAM, which can include non-volatile RAM, magnetic RAM, ferroelectric RAM, and any other suitable forms); non-volatile memory (e.g., disk memory, FLASH memory, EPROMs, EEPROMs, memristor-based non-volatile solid-state memory, etc.), unalterable memory (e.g., EPROMs), read-only memory, and/or high-capacity storage devices (e.g., hard drives, solid state drives, etc). In some examples, the memory 308 includes multiple kinds of memory, particularly volatile memory and non-volatile memory.

The memory 308 is computer readable media on which one or more sets of instructions, such as the software for operating the methods of the present disclosure can be embedded. The instructions may embody one or more of the methods or logic as described herein. In a particular embodiment, the instructions may reside completely, or at least partially, within any one or more of the memory 308, the computer readable medium, and/or within the processor 306 during execution of the instructions.

The terms “non-transitory computer-readable medium” and “tangible computer-readable medium” should be understood to include a single medium or multiple media, such as a centralized or distributed database, and/or associated caches and servers that store one or more sets of instructions. The terms “non-transitory computer-readable medium” and “tangible computer-readable medium” also include any tangible medium that is capable of storing, encoding or carrying a set of instructions for execution by a processor or that cause a system to perform any one or more of the methods or operations disclosed herein. As used herein, the term “tangible computer readable medium” is expressly defined to include any type of computer readable storage device and/or storage disk and to exclude propagating signals.

The vehicle data bus 304 communicatively couples the [the DSRC module 106, the on-board communications module 108, and/or the body control module 110. In some examples, the vehicle data bus 304 includes one or more data buses. The vehicle data bus 304 may be implemented in accordance with a controller area network (CAN) bus protocol as defined by International Standards Organization (ISO) 11898-1, a Media Oriented Systems Transport (MOST) bus protocol, a CAN flexible data (CAN-FD) bus protocol (ISO 11898-7) and/a K-line bus protocol (ISO 9141 and ISO 14230-1), and/or an Ethernet™ bus protocol IEEE 802.3 (2002 onwards), etc.

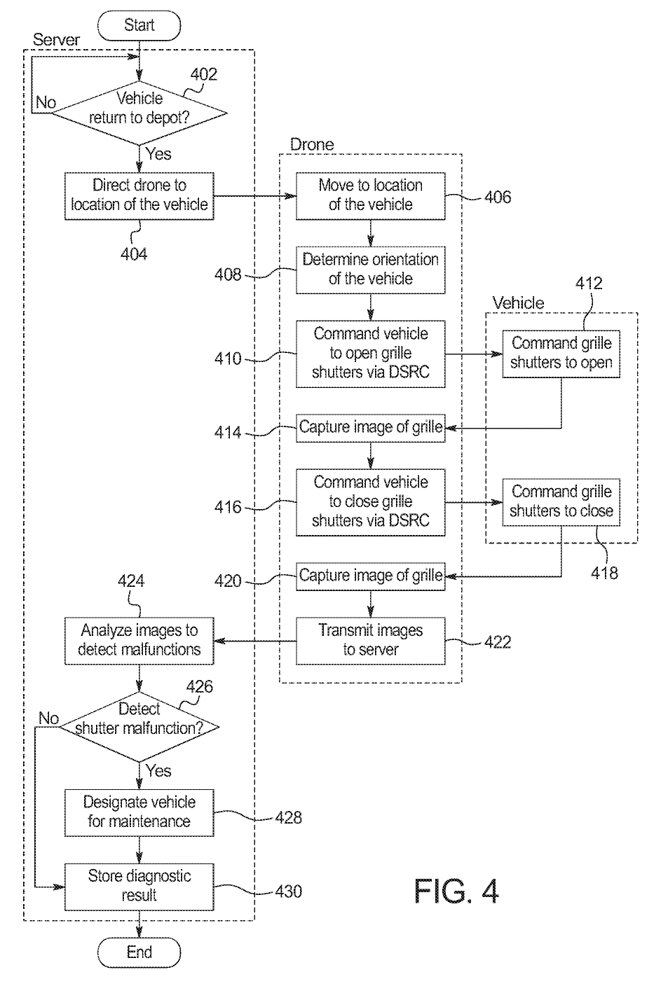

FIG. 4 is a flowchart of a method to diagnose the active grille shutters 102, which may be implemented by the diagnostic server 116, the drone 100, and/or the vehicle 104 of FIG. 1. Initially, at block 402, the diagnostic server 116 waits until the vehicle 104 returns to the depot. In some examples, the diagnostic server 116 determines that the vehicle 104 has returned to the depot when sensors (e.g., motions sensors, cameras, a tracking sensor, etc.) detect the vehicle 104 and/or the vehicle 104 notifies the diagnostic server 116 (e.g., via the DSRC module 106 and/or the on-board communications module 108, etc.). At block 404, the diagnostic server 116 directs the drone 100 to the location of the vehicle 104.

At block 406, the drone 100 maneuvers to the location of the vehicle 104. At block 408, the drone 100 determines the orientation of the vehicle 104 and maneuvers so the active grille shutters 102 of the vehicle 104 are viewable by the camera(s) 114. At block 410, the drone 100, via the DSRC module 112, sends a comment to the vehicle 104 to open its active grille shutters 102.

At block 412, the vehicle 104, via the body control module 110, commands the active grille shutters 102 to open. When the active grille shutters 102 are functioning properly, they will open.

At block 414, the drone 100 captures an image of the active grille shutters 102. In some examples, during the day, the drone 100 uses the standard camera 114 to capture the image. In some examples, during the night, the drone 100 uses the infrared camera 114 to capture the image. At block 416, the drone 100, via the DSRC module 112, sends a comment to the vehicle 104 to close its active grille shutters 102.

At block 418, the vehicle 104, via the body control module 110, commands the active grille shutters 102 to close. When the active grille shutters 102 are functioning properly, they will close.

At block 420, the drone 100 captures another image of the active grille shutters 102. At block 422, the drone 100 transmits the images to the diagnostic server 116. The drone 100 then returns to its dock or continues to the next vehicle.

At block 424, the diagnostic server 116 analyzes the images received from the drone 100. At block 426, the diagnostic server 116 determines whether the images indicate that the active griller shutters 102 of the vehicle 104 are malfunctioning. When the active griller shutters 102 of the vehicle 104 are malfunctioning, the method continues at block 428. Otherwise, when the active griller shutters 102 of the vehicle 104 are not malfunctioning, the method continues at block 430. At block 428, the diagnostic server designates the vehicle 104 for maintenance. At block 430, the diagnostic server 116 stores the results of the image analysis.

The flowchart of FIG. 4 is representative of machine readable instructions stored in memory (such as the memory 216 of FIG. 2 and/or the memory 308 of FIG. 3) that comprise one or more programs that, when executed by one or more processors (such as the processor 214 of FIG. 2 and/or the processor 306 of FIG. 3), cause the drone 100, the vehicle 104, and/or the diagnostic server 116 to implement the example system of FIG. 1. Further, although the example program(s) is/are described with reference to the flowchart illustrated in FIG. 4, many other methods of implementing the example system may alternatively be used. For example, the order of execution of the blocks may be changed, and/or some of the blocks described may be changed, eliminated, or combined.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects. Further, the conjunction “or” may be used to convey features that are simultaneously present instead of mutually exclusive alternatives. In other words, the conjunction “or” should be understood to include “and/or”. The terms “includes,” “including,” and “include” are inclusive and have the same scope as “comprises,” “comprising,” and “comprise” respectively.

The above-described embodiments, and particularly any “preferred” embodiments, are possible examples of implementations and merely set forth for a clear understanding of the principles of the invention. Many variations and modifications may be made to the above-described embodiment(s) without substantially departing from the spirit and principles of the techniques described herein. All modifications are intended to be included herein within the scope of this disclosure and protected by the following claims.

What is claimed is:

1. A vehicle diagnostic system comprising:
a drone to:
send a first command to open a vehicle's active grille shutters;
capture a first image of a front of the vehicle;
send a second command to close the active grille shutters;
capture a second image of the front of the vehicle; and
a diagnostic server to determine whether the active grille shutters are malfunctioning based on the first and second images received from the drone.

2. The system of claim 1, wherein the drone includes a wireless transceiver to communicate with the vehicle.

3. The system of claim 2, wherein the wireless transceiver implements a dedication short range communication protocol.

4. The system of claim 1, wherein the drone includes a first camera to capture the first and second images in an visible spectrum, and a second camera to capture the first and second images in an infrared spectrum.

5. The system of claim 4, wherein the drone is to:
capture the first and second images with the first camera when an area is around the vehicle is illuminated; and
capture the first and second images with the second camera when the area is around the vehicle is dark.

6. The system of claim 1, wherein the drone is an unmanned aerial vehicle.

7. The system of claim 1, wherein the drone is an unmanned ground vehicle.

8. The system of claim 1, wherein determine whether the active grille shutters are malfunctioning, the diagnostic server is to analyze the first and second images using at least one of image subtraction or a comparison of pixel brightness.

9. The system of claim 1, wherein the diagnostic server is to dispatching the drone to maneuver to the vehicle in response to detecting the vehicle park in a depot.

10. The system of claim 1, where the drone is to determine an orientation of the vehicle to maneuver so that a camera of the drone is facing a front of the vehicle.

11. A method comprising:
sending, by a wireless transceiver of a drone, a first command to open a vehicle's active grille shutters;
capturing, by a camera of the drone, a first image of a front of the vehicle;
sending, by the wireless transceiver of the drone, a second command to close the active grille shutters;
capturing, by the camera of the drone, a second image of the front of the vehicle; and
determining, by a diagnostic server, whether the active grille shutters are malfunctioning based on the first and second images received from the drone.

12. The method of claim 11, wherein the camera of the drone includes a visible spectrum mode and an infrared spectrum mode.

13. The method of claim 12, wherein capturing the first and second images include:
capturing the first and second images with the camera in the visible spectrum mode when an area around the vehicle is illuminated; and
capturing the first and second images with the camera in an infrared mode when the area around the vehicle is dark.

14. The method of claim 11, including dispatching, by the diagnostic server, the drone to maneuver to the vehicle in response to detecting the vehicle park in a depot.

15. The method of claim 11, wherein determining whether the active grille shutters are malfunctioning includes analyzing, by the diagnostic server, the first and second images using at least one of image subtraction or comparison of pixel brightness.
